(19) United States
(12) Patent Application Publication
(10) Pub. No.: US 2006/0232127 A1
(43) Pub. Date: Oct. 19, 2006

(54) Method for monitoring a braking torque modification of a retarder

(76) Inventor: Roland Scherer, Crailsheim (DE)

Correspondence Address: BAKER & DANIELS LLP;111 E. WAYNE STREET, SUITE 800, FORT WAYNE, IN, 46802, US

(21) Appl. No.: 10/554,482

(22) PCT Filed: Nov. 27, 2004
(86) PCT No.: PCT/EP04/13467

§ 371 Date: Oct. 24, 2005

(30) Foreign Application Priority Data
Dec. 23, 2003 (DE) 103 61 448.6

(51) Int. Cl. B60T 8/60

(52) U.S. Cl. 303/155; 188/181 T

(57) ABSTRACT

The invention relates to a method for monitoring a braking torque modification of a retarder, in particular of a motor vehicle, said braking torque modification being controlled by an actuating pressure control circuit comprising a pressure sensor that is connected in said circuit. The method comprises the following steps: the actuating pressure of the retarder is dynamically detected by means of the pressure sensor that is mounted in the actuating pressure control circuit; the temporal progression of the detected actuating pressure is compared with at least one predetermined target progression; a warning is issued and/or a future activation of the retarder by a user, in particular the driver of the vehicle, is prevented, based on the actual-target comparison and if predetermined criteria have been fulfilled.

The present invention relates to the monitoring of a braking torque modification of a retarder, whereby the braking torque modification is controlled by an actuating pressure control circuit. In particular the invention relates to a method for the monitoring of a braking torque modification or for the monitoring of a braking torque modification and for the detection of errors.

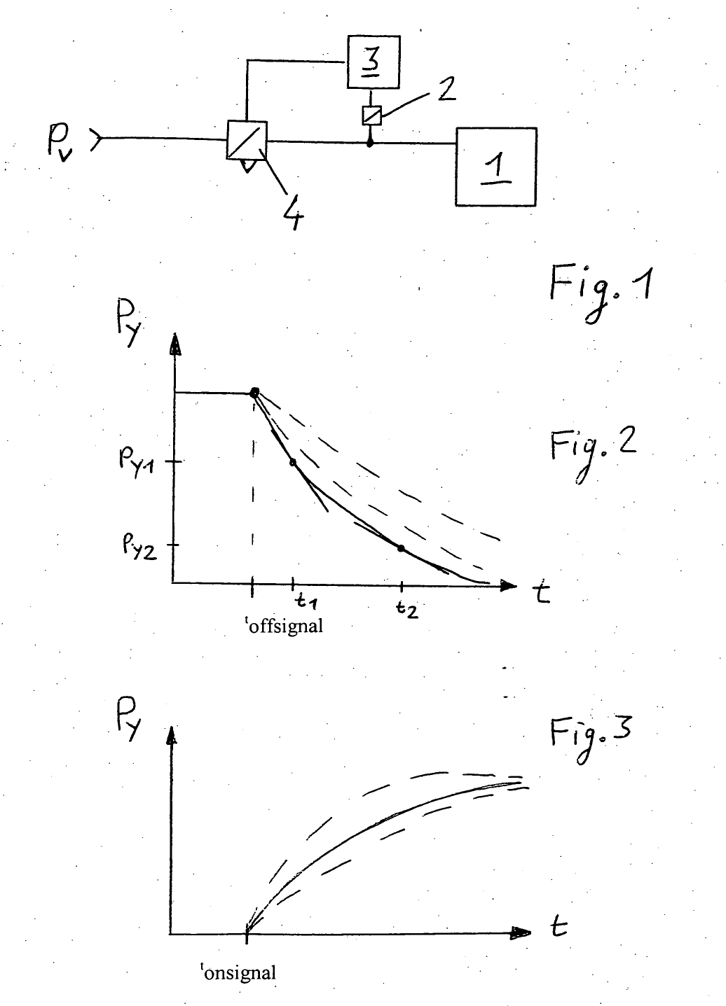

Usually retarders of motor vehicles as well as comparable systems are controlled or steered by means of actuating pressure (pneumatic pressure pY) that can be metered regularly or continuously, whereby a pressure sensor is installed in the actuating pressure control circuit. This pressure sensor is used exclusively for control purposes or for tolerance minimization in the setting of a predetermined actuating pressure for the retarder. FIG. 1 shows such a retarder system with an electronic control unit, whereby the retarder is labeled with reference symbol 1, the pressure sensor with reference symbol 2, and the electric control unit is represented by reference symbol 3, as well as an electro-pneumatic valve represented by reference symbol 4. Pᵥ designates the pressure of a reservoir system for the working fluid of the retarder, whereby the working fluid is for example stored in an air brake reservoir.

Since retarders, also called hydrodynamic brakes, have the function of an additional braking system, deactivation or immobilization in the case of an error is permissible for example in the control system. Simply put, this means that the safe state is the off state. In the development of retarder systems one is hence endeavoring to provide means for the safe deactivation of the retarder as well as the securing of this deactivation during the entire service life of the retarder system. An undesired modification of the deactivation behavior of a retarder can result in damage to the vehicle system or in the worst case scenario, can lead to accidents. Thus, for example, in the case of a too slow deactivation of the retarder in a critical situation the danger exists that the vehicle will skid.

The invention is based on the object of presenting a method for monitoring a predetermined braking torque modification which on the one hand stands out due to a high reliability and on the other hand can be implemented in an existing retarder overall system without considerable additional expense or in particular without causing the provision of additional components.

The object of the invention is solved by a method with the features of claim 1, further by an inventive usage in accordance with claim 13. The dependent claims describe particularly expedient embodiments of the invention.

By means of the inventive method it is possible to make available a secure monitoring of a braking torque modification, for example a deactivation process or an activation process. In accordance with the invention the pressure sensor that is present in the actuating pressure control circuit of the retarder is used for detection of the dynamic progression of the actuating pressure, whereby the control circuit is used to control the retarder braking torque by the application of a predetermined actuating pressure on the retarder input. This detected dynamic progression hence represents an actual progression and is compared with at least one predetermined target progression. Using the results of this target-actual comparison, provided predetermined criteria are fulfilled, for example when the actual progression deviates from the target progression by a predetermined extent, a warning is issued and alternately or in addition the retarder or the retarder control, which takes place by means of a retarder control unit, can be set to a state which prevents a future activation of the retarder by the driver of the vehicle. In a manner of speaking the retarder is immobilized. Such an immobilization can then be overridden again, for example by a specialist repair shop after elimination of the defects which resulted in the deviation of the actual progression in comparison with the target progression.

In accordance with an expedient embodiment of the invention the target progression is predetermined in the form of at least one target characteristic. Such a characteristic can for example be stored in the retarder control unit. The retarder control unit also expediently performs the comparison of the actual progression with the target progression. In accordance with an expedient embodiment of the invention at least two target characteristics are predetermined, namely a first warning characteristic and a second mobilization characteristic. Upon “violation” of the warning characteristic by the actual progression a warning is issued, while upon “violation” of the immobilization characteristic the above described immobilization of the retarder is performed. How such a “violation” of the characteristics can be detected and assessed will be described in detail in the following.

The predetermined target characteristics, which if necessary can be a single target characteristic, can be system-oriented characteristics calculated during the construction of the retarder system or determined by trial, in particular so-called “worst-case” characteristics, that is, characteristics which are created upon assumption of the occurrence of possible unfavorable states in the system. Additionally, variable state data of the system or the environment, such as for example the ambient temperature, the vehicle mass, the axle load etc. can be considered in the characteristics. Alternatively or in addition, for each vehicle or for each retarder an “adaptive” characteristic can be “programmed” at the beginning of the operating time, that is, this characteristic is set based on operating data detected at the beginning of the vehicle operating time.

By means of the comparison of the actual progression, that is the temporal progression of the determined actuating pressure, with the target progression it is possible to detect critical changes, that is, unusual modifications of the ventilation behavior of the actuating pressure, in particular in the case of the largely complete draining of the retarder or the draining of the retarder to a predetermined filling capacity and to initiate suitable measures. In case for example a warning limit is predetermined, by means of the comparison a decision can be made as to whether the retarder system can continue to be used (for example with a warning to the driver of the vehicle that the system has to be checked) or whether effective immediately the retarder can no longer be used and for example will be deactivated by retarder control (in this case, expediently a warning is issued to the operator that the retarder has been put out of operation).

In accordance with an expedient embodiment of the invention the predetermined target progression comprises two target characteristics, namely a warning characteristic and an immobilization characteristic. Either the detected temporal progression of the actuating pressure is immediately compared with the two characteristics or first only with the warning characteristic. With the help of the results of the comparison of the detected temporal progression of the actuating pressure to the warning characteristic a decision is then made as to whether a comparison with the immobilization characteristic is also necessary. For example, in case the retarder torque is to be reduced, that is, if a braking torque reduction is predetermined by the actuating pressure control circuit, after exceeding the warning characteristic a comparison of the detected actuating pressure to the immobilization characteristic should expediently take place. If in this case the warning characteristic is not exceeded, that is, if the actual progression takes place so close to the predetermined target progression that no warning is necessary, the comparison with the immobilization characteristic can be dispensed with.

On the other hand, in case a retarder filling is taking place, that is, if the actuating pressure control circuit predetermines a braking torque increase of the retarder, first a comparison is conducted to determine whether the actual progression falls below the warning characteristic. If this is the case, the detected temporal progression of the actuating pressure is compared with the immobilization characteristic. In this case the last comparison can be eliminated if the warning criterion is not fulfilled, that is, if the actual progression takes place so close to the target progression that it does not fall below the warning characteristic.

In the case of an exceeding or falling below of the warning characteristic—depending on the control case—a warning is expediently issued to the operator. In the case of a corresponding exceeding or falling below of the immobilization characteristic the retarder system is expediently immobilized, as already described above.

The exceeding or falling below of the target characteristics by the actual progression was presented in the example just described with the help of a comparison of the absolute pressure progressions. However, it is also possible to use other variables for error detection or for monitoring the braking torque modification, for example the time between two predetermined points of pressure, which are passed through by the actuating pressure. Another possibility is the comparison of the actuating pressure gradient in one or more predetermined points of pressure. The advantage of the gradient comparison is the independence from the retarder braking torque which is set as the target default of the retarder control circuit.

Of course it is also possible to monitor actuating pressure increases, that is, predetermined increases of the retarder braking torque, by means of the inventive method. The pneumatic braking pressure is used expediently as an additional influencing variable in the predetermined target characteristics, that is, the pressure of the air brake reservoir system, for example in or behind an air brake reservoir with working fluid of the retarder, since this has a direct influence on the increase gradients of the actuating pressure. In vehicles which have the braking pressure (pV) available as a test signal, this can be included in the comparison of the actual progression with the target progression. In case of error, that is, in the case of an increase in pressure outside the target characteristic, the possibility should be expediently taken into consideration that a malfunction of the braking pressure test signal can also be present.

In vehicles without a braking pressure test signal the minimum possible braking pressure (pVmin) as well as the maximum possible braking pressure (pVmax) are expediently taken into consideration in the creation of the target progression or the target characteristics. For example, in the dynamic comparison of the actual actuating pressure with the target progression a lower and an upper target characteristic can be taken into consideration, namely a target characteristic which considers the minimum possible braking pressure and a target characteristic which considers the maximum possible braking pressure. The actuating pressure (actual progression) should then run between these two target characteristics as limiting curves.

The inventive method makes possible the detection of malfunctions both in the deactivation as well as in the activation of the retarder. Furthermore, the progression during a braking torque modification can be monitored at a pre-selected target braking torque, whereby the braking torque is greater than zero and is less than the maximum braking torque of the retarder.

Sources of error which can for example lead to pressure gradients deviating from the target progression are in particular a disturbance of the electro-pneumatic control valve with which the actuating pressure is set, for example by foreign bodies or internal defects, a leakage or cross-sectional changes. A further error cause can lie in a malfunction of the pressure sensor. Of course, the retarder can also be directly disturbed by foreign bodies, a leakage or cross-sectional changes, as well there being errors in the control unit or in the braking pressure system.

The invention will be explained in greater detail with the help of the attached figures.

The figures show the following:

FIG. 1 shows a schematic representation of an actuating pressure control circuit in whose control unit (electronic control unit) the inventive method can be implemented;

FIG. 2 shows an example of a detected actual progression and the target characteristics of the target progression when the retarder is deactivated;

FIG. 3 shows an example of two target characteristics when the retarder is being activated.

In FIGS. 2 and 3 the actuating pressure P_{Y} is plotted in its temporal progression, that is, over the time t. In each case, two target characteristics are represented by dashed lines and the actual progression is represented by a solid line. In addition FIG. 2 shows the actuating pressure gradients P_{Y1} at the time t₁ and P_{Y2} at time t₂.

In FIG. 2 the actuating pressure runs first on a linear high level, that is, the retarder brakes with a correspondingly great braking torque. As soon as the operator, by means of activating a corresponding input device, has selected the function that the retarder is to be deactivated, the actuating pressure P_{Y} begins dropping starting with time t_{AUSSIGNAL}. As one can see, in the represented example the deactivation process runs in the uncritical region, that is below the warning characteristic and the immobilization characteristic arranged above it.

FIG. 3 shows the activation process, beginning at the time of the t_{EINSIGNAL} activation signal. Here too the activation process runs in the uncritical region, that is between a predetermined first (minimum) target characteristic based on a minimum possible pressure in an air brake reservoir for the working fluid of the retarder and a second (maximum) target characteristic based on a maximum possible pressure in the air brake reservoir.

1. Method for monitoring a braking torque modification of a retarder, in particular of a motor vehicle, said braking torque modification being controlled by an actuating pressure control circuit comprising a pressure sensor that is connected in said circuit. The method comprises the following steps:
the actuating pressure of the retarder is dynamically detected by means of the pressure sensor that is mounted in the actuating pressure control circuit;
the temporal progression of the detected actuating pressure is compared with at least one predetermined target progression;
a warning is issued and/or a future activation of the retarder by a user, in particular the driver of the vehicle, is prevented, based on the actual-target comparison and if predetermined criteria have been fulfilled.

2. Method in accordance with claim 1, characterized by the fact that the predetermined target progression is stored in the form of at least one target characteristic, in particular in a retarder control unit.

3. Method in accordance with claim 1, characterized by the fact that the comparison is performed by the retarder control unit.

4. Method in accordance with claim 2, characterized by the fact that the predetermined target progression comprises two target characteristics, an advance warning characteristic and an immobilization characteristic, whereby the temporal progression of the detected actuating pressure is compared with both characteristics or is first compared with the warning characteristic and in the case of a braking torque decrease predetermined by the actuating pressure control circuit upon the exceeding of the warning characteristic and in the case of a braking torque increase predetermined by the actuating pressure control circuit upon the falling below of the warning characteristic is then compared with the immobilization characteristic, and upon the exceeding of the warning characteristic of the predetermined braking torque decrease and up the falling below of the warning characteristic in the case of the predetermined braking torque increase a warning is issued; and upon the exceeding of the immobilization characteristic in the case of the predetermined braking torque decrease and upon the falling below of the immobilization characteristic in the case of the predetermined braking torque increase a future activation of the retarder by a user, in particular the driver of the vehicle, is prevented.

5. Method in accordance with claim 2, characterized by the fact that the target characteristic, of which there is at least one, is stored based on specific design data of the individual motor vehicle system and variable, detected state data of the motor vehicle system and/or the environment.

6. Method in accordance with claim 2, characterized by the fact that the target characteristic, of which there is at least one, is stored as an adaptive characteristic based on the operating data detected at the beginning of the vehicle operating time.

7. Method in accordance with claim 2, characterized by the fact that the comparison comprises the comparing of the times between two predetermined actuating pressure points of the detected temporal progression of the actuating pressure and of the predetermined target characteristic, of which there is at least one.

8. Method in accordance with claim 2, characterized by the fact that the comparison comprises the comparing of the actuating pressure gradients at predetermined actuating pressure points of the detected temporal progression and of the predetermined target characteristic, of which there is at least one.

9. Method in accordance with claim 2, characterized by the fact that at least a first target characteristic of the minimum actuating pressure and a second target characteristic of the maximum actuating pressure are stored.

10. Method in accordance with claim 9, characterized by the fact that a braking torque increase of a retarder is monitored, and the first target characteristic is created based on a minimum possible pressure in an air brake reservoir for working fluid of the retarder, and the second target characteristic is created based on a maximum possible pressure in the air brake reservoir.

11. Method in accordance with claim 1, characterized by the fact that a deactivation process of the retarder is monitored.

12. Method in accordance with claim 1, characterized by the fact that a braking torque reduction of the retarder is monitored at a predetermined braking torque.

13. Use of a pressure sensor installed in an actuating pressure control circuit of a retarder for the dynamic monitoring of the actuating pressure and for error detection.

14. Method in accordance with claim 2, characterized by the fact that the comparison is performed by the retarder control unit.

15. Method in accordance with claim 3, characterized by the fact that the predetermined target progression comprises two target characteristics, an advance warning characteristic and an immobilization characteristic, whereby the temporal progression of the detected actuating pressure is compared with both characteristics or is first compared with the warning characteristic and in the case of a braking torque decrease predetermined by the actuating pressure control circuit upon the exceeding of the warning characteristic and in the case of a braking torque increase predetermined by the actuating pressure control circuit upon the falling below of the warning characteristic is then compared with the immobilization characteristic, and upon the exceeding of the warning characteristic of the predetermined braking torque decrease and up the falling below of the warning characteristic in the case of the predetermined braking torque increase a warning is issued; and upon the exceeding of the immobilization characteristic in the case of the predetermined braking torque decrease and upon the falling below of the immobilization characteristic in the case of the predetermined braking torque increase a future activation of the retarder by a user, in particular the driver of the vehicle, is prevented.

16. Method in accordance with claim 3, characterized by the fact that the target characteristic, of which there is at least one, is stored based on specific design data of the individual motor vehicle system and variable, detected state data of the motor vehicle system and/or the environment.

17. Method in accordance with claim 4, characterized by the fact that the target characteristic, of which there is at least one, is stored based on specific design data of the individual motor vehicle system and variable, detected state data of the motor vehicle system and/or the environment.

18. Method in accordance with claim 3, characterized by the fact that the target characteristic, of which there is at least one, is stored as an adaptive characteristic based on the operating data detected at the beginning of the vehicle operating time.

19. Method in accordance with claim 4, characterized by the fact that the target characteristic, of which there is at least one, is stored as an adaptive characteristic based on the operating data detected at the beginning of the vehicle operating time.

20. Method in accordance with claim 5, characterized by the fact that the target characteristic, of which there is at least one, is stored as an adaptive characteristic based on the operating data detected at the beginning of the operating time.
